(19) United States
(12) Patent Application Publication
(10) Pub. No.: US 2018/0249190 A1
(43) Pub. Date: Aug. 30, 2018

(54) METHOD AND APPARATUS FOR CLOUD STORAGE AND CLOUD DOWNLOAD OF MULTIMEDIA DATA

(71) Applicant: ALIBABA GROUP HOLDING LIMITED, George Town (KY)

(72) Inventors: Yigang WU, Hangzhou (CN); Hua CAI, Hangzhou (CN); Hao ZHOU, Hangzhou (CN)

(73) Assignee: ALIBABA GROUP HOLDING LIMITED

(21) Appl. No.: 15/965,782

(22) Filed: Apr. 27, 2018

Related U.S. Application Data
(63) Continuation of application No. PCT/CN2016/102647, filed on Oct. 20, 2016.

(30) Foreign Application Priority Data
Oct. 29, 2015 (CN) 201510719292.9

(51) Int. Cl. H04N 21/231; H04N 21/235; H04N 21/2347

(52) U.S. Cl. CPC H04N 21/231; H04N 21/23473; H04N 21/2353

(57) ABSTRACT

The present application provides methods and apparatuses for cloud storage and cloud download for multimedia data. One exemplary cloud storage method includes: a push device sending a verification request to a server, the verification request being used for requesting verification of storage permission of the push device; the push device receiving a verification success message sent by the server, the verification success message including storage permission information about a specified address of a cloud storage device; the push device locally caching the multimedia data; and the push device storing the locally cached multimedia data at the specified address of the cloud storage device by using the storage permission information. With this method, the server does not need to perform local caching, and only performs permission verification. A push device can directly store the multimedia data, thereby reducing the occupied resources of the server.

### CROSS REFERENCE TO RELATED APPLICATION

This application claims the priority to International Application No. PCT/CN2016/102647, filed on Oct. 20, 2016, and claims priority to Chinese Patent Application No. 201510719292.9, filed on Oct. 29, 2015, both of which are incorporated herein by reference in their entireties.

### TECHNICAL FIELD

The present application generally relates to the field of cloud storage, and in particular to methods and apparatuses for cloud storage and cloud download of multimedia data.

### BACKGROUND

With the increasing demand for storing multimedia data, conventional storage techniques such as block storage cannot satisfy the requirements for high concurrency, high throughput, high performance and the like. Cloud storage techniques are now widely used.

With reference to FIG. 1, in a cloud storage system for multimedia data, an existing cloud storage method can include: a push device such as a video capturing device pushing multimedia data to a server, and the server locally caching the multimedia data and storing the cached multimedia data in a cloud storage device. An existing cloud download process includes: a user terminal sending a download request to a server; and the server searching for and locally caching multimedia data from a cloud storage device and sending the cached multimedia data to the user terminal.

According to the above methods, when storing multimedia data in or downloading from the cloud storage device, local caching needs to be performed through a server. This occupies resources of the server. When a plurality of push devices simultaneously store multimedia data in the cloud storage device, or a plurality of user terminals simultaneously download multimedia data from the cloud storage device, the server needs to locally cache large amounts of multimedia data. In such cases, a large amount of server resources may be occupied. The occupation of server resources can cause high hardware costs for the server.

### SUMMARY

Embodiments of the present application provide methods and apparatuses for cloud storage and cloud download of multimedia data. One advantage of some embodiments of the present application is that a server does not need to perform local caching when storing or downloading multimedia data in or from a cloud storage device. This can help reduce the occupied resources of the server and reduce related hardware costs.

According to some embodiments of the present application, methods of cloud storage are provided. One exemplary cloud storage method includes: a push device sending a verification request to a server, the verification request being used for requesting verification of storage permission of the push device; the push device receiving a verification success message sent by the server, the verification success message including storage permission information about a specified address on a cloud storage device; the push device locally caching the multimedia data; and the push device storing the locally cached multimedia data at the specified address of the cloud storage device by using the storage permission information.

According to some embodiments of the present application, the cloud storage method can further include: the push device acquiring key frame information about the multimedia data, and generating an index file according to the key frame information; and the push device storing the index file at the specified address of the cloud storage device by using the storage permission information.

According to some embodiments of the present application, the cloud storage method can further include: the push device encrypting a key frame in the multimedia data before storing the locally cached multimedia data at the specified address; and the push device adding information indicating that the key frame has been encrypted to the key frame information before storing the index file at the specified address.

According to some embodiments of the present application, the cloud storage method can further include: the push device generating label information, the label information being used for describing a data characteristic of the multimedia data; and the push device adding the label information to the index file before storing the index file at the specified address.

According to some embodiments of the present application, the cloud storage method can further include: the push device generating signature information, the signature information being capable of uniquely identifying a key frame of the multimedia data; and the push device adding the signature information into a user-defined information segment of the multimedia data before storing the locally cached multimedia data at the specified address.

According to some embodiments of the present application, the cloud storage method can further include: the push device successively caching the multimedia data as a plurality of data slices. The step of the push device storing the locally cached multimedia data at the specified address can further include: the push device storing the successively cached plurality of data slices at the specified address in an appended object storage manner.

According to some embodiments of the present application, permission verification methods for cloud storage processes are provided. One exemplary permission verification method includes: a server receiving a verification request sent by a push device, the verification request being used for requesting verification of storage permission of the push device; the server verifying that the push device has the storage permission; the server generating storage permission information about a specified address on a cloud storage device; and the server sending a verification success message to the push device, the verification success message including the storage permission information.

In some embodiments, the verification request can further indicate the multimedia data to be stored by the push device. Before generating the storage permission information, the permission verification method can further include: generating a specified folder on the cloud storage device, and taking the address corresponding to the specified folder as the specified address if the server determines that the multimedia data does not exist on the cloud storage device; and taking the address where partial data of the multimedia data is located as the specified address if the server determines that the partial data of the multimedia data exists on the cloud storage device.

In some embodiments, a first-level directory of the multimedia data corresponds to a capturing device identifier, and a second-level directory corresponds to storage time.

According to some embodiments of the present application, methods for cloud download of multimedia data are provided. One exemplary method includes: a user terminal sending a verification request to a server, the verification request being used for requesting verification of download permission of the push device; the user terminal receiving a verification success message sent by the server, the verification success message including download permission information about a specified address of a cloud storage device; and the user terminal downloading multimedia data from the specified address by using the download permission information.

According to some embodiments of the present application, the cloud download method can further include: the user terminal downloading an index file from the specified address by using the download permission information, the index file including key frame information about the multimedia data.

According to some embodiments of the present application, the cloud download method can further include: the user terminal parsing the index file to obtain the key frame information; and the user terminal playing the multimedia data according to the key frame information.

According to some embodiments of the present application, the cloud download method can further include: the user terminal decrypting the key frame before playing the multimedia data according to the key frame information if, from the key frame information, the user terminal acquires information indicating that the key frame has been encrypted.

According to some embodiments of the present application, methods for permission verification used in a cloud download process are provided. One exemplary permission verification method includes: a server receiving a verification request sent by a user terminal, the verification request being used for requesting verification of download permission of the user terminal; the server verifying that the user terminal has the download permission; the server generating download permission information about a specified address on a cloud storage device; and the server sending a verification success message to the user terminal, the verification success message including the download permission information.

According to some embodiments of the present application, the permission verification method can further include: the server acquiring the most recently stored multimedia data and taking the address of the most recently stored multimedia data as the specified address, if the user terminal is in a live state; and the server acquiring an identifier of on-demand data of the user terminal and taking the storage address corresponding to the identifier of the on-demand data as the specified address, if the user terminal is in an on-demand state.

According to some embodiments of the present application, push devices for pushing multimedia data are provided. One exemplary push device include: a sending unit, a receiving unit and a caching unit. The sending unit is configured to send a verification request to a server, the verification request being used for requesting verification of storage permission of the push device. The receiving unit is configured to receive a verification success message sent by the server, the verification success message including storage permission information about a specified address of a cloud storage device. The caching unit is configured to locally cache multimedia data. The sending unit is further configured to store the locally cached multimedia data at the specified address of the cloud storage device by using the storage permission information.

According to some embodiments of the present application, the push device can further include a first generation unit configured to acquire key frame information about the multimedia data and generate an index file according to the key frame information. The sending unit can be further configured to store the index file at the specified address of the cloud storage device by using the storage permission information.

According to some embodiments of the present application, the push device can further include an encryption unit configured to encrypt a key frame in the multimedia data before the sending unit stores the locally cached multimedia data at the specified address; and a first addition unit configured to add information indicating that the key frame has been encrypted to the key frame information before the sending unit stores the index file at the specified address.

According to some embodiments of the present application, the push device can further include: a second generation unit configured to generate label information, the label information being used for describing a data characteristic of the multimedia data; and a second addition unit configured to add the label information to the index file before the sending unit stores the index file at the specified address.

According to some embodiments of the present application, the push device can further include: a third generation unit configured to generate signature information, the signature information being capable of uniquely identifying a key frame of the multimedia data; and a third addition unit configured to add the signature information into a user-defined information segment of the multimedia data before the sending unit stores the locally cached multimedia data at the specified address.

According to some embodiments of the present application, the caching unit can be further configured to successively cache the multimedia data as a plurality of data slices; and the sending unit can be further configured to store the successively cached plurality of data slices at the specified address in an appended object storage manner when storing the locally cached multimedia data at the specified address.

According to some embodiments of the present application, servers are provided. One exemplary server includes: a receiving unit configured to receive a verification request sent by a push device, the verification request being used for requesting verification of storage permission of the push device; a verification unit configured to verify that the push device has the storage permission; a generation unit configured to generate storage permission information about a specified address on a cloud storage device after the verification unit verifies that the push device has the storage permission; and a sending unit configured to send a verification success message to the push device, the verification success message including the storage permission information.

According to some embodiments of the present application, the verification request can further indicate the multimedia data to be stored by the push device; and the server can further include a determination unit. The determination unit can be further configured to generate a specified folder on the cloud storage device before the generation unit generates the storage permission information and take the address corresponding to the specified folder as the specified address, if it is determined that the multimedia data does not exist on the cloud storage device; and take the address where partial data of the multimedia is located as the specified address, if it is determined that the partial data of the multimedia data exists on the cloud storage device.

In some embodiments, a first-level directory of the multimedia data corresponds to a capturing device identifier, and a second-level directory corresponds to storage time.

According to some embodiments of the present application, user terminals are provided. One exemplary user terminal includes: a sending unit configured to send a verification request to a server, the verification request being used for requesting verification of download permission of the push device; a receiving unit configured to receive a verification success message sent by the server, the verification success message including download permission information about a specified address of a cloud storage device; and a download unit configured to download multimedia data from the specified address by using the download permission information.

According to some embodiments, the download unit can be further configured to download an index file from the specified address by using the download permission information, the index file including key frame information about the multimedia data.

According to some embodiments of the present application, the user terminal can further include: a parsing unit configured to parse the index file to obtain the key frame information; and a playing unit configured to play the multimedia data according to the key frame information.

According to some embodiments, the user terminal can further include: a decryption unit configured to decrypt a key frame before the multimedia data is played according to the key frame information, if information is acquired from the key frame information indicating that the key frame has been encrypted.

According to some embodiments of the present application, servers are provided. One exemplary server includes: a receiving unit configured to receive a verification request sent by a user terminal, the verification request being used for requesting verification of download permission of the user terminal; a verification unit configured to verify that the user terminal has the download permission; a generation unit configured to generate download permission information about a specified address on a cloud storage device after the verification unit verifies that the user terminal has the download permission; and a sending unit configured to send a verification success message to the user terminal, the verification success message including the download permission information.

According to some embodiments, the server can further include an acquisition unit configured to acquire the most recently stored multimedia data and take the address of the most recently stored multimedia data as the specified address, if the user terminal is in a live state; and acquire an identifier of on-demand data of the user terminal and take the storage address corresponding to the identifier of the on-demand data as the specified address, if the user terminal is in an on-demand state.

In view of the above, according to some embodiments of the present application, at the time of cloud storage, a push device sends a verification request to a server, so that the server can verify the storage permission of the push device. If the server verifies that the push device has the storage permission, the push device can receive a verification success message sent by the server. According to the storage permission information in the verification success message, the push device stores the multimedia data locally cached by the push device at the specified address of the cloud storage device. According to some embodiments of the present application, at the time of cloud download, a user terminal sends a verification request to a server, so that the server can verify the download permission of the user terminal. If the server verifies that the user terminal has the download permission, the user terminal can receive a verification success message sent by the server. The user terminal downloads multimedia data from the specified address of the cloud storage device according to the download permission information in the verification success message.

According to the embodiments of the present application, there is no need for a server to perform data relays at the time of cloud storage or cloud download of multimedia data. That is, the server does not need to perform local caching. Rather, the server performs permission verification, and a push device directly stores the multimedia data, or a user terminal directly downloads the multimedia data. That way, it can help reduce the occupied resources of the server and reduce hardware costs. In addition, in the embodiments of the present application, even though a server does not perform data relay, it performs permission verification. Therefore, it can ensure security in the cloud storage or cloud download process while reducing the occupied resources.

### BRIEF DESCRIPTION OF THE DRAWINGS

FIG. 1 is a structural schematic diagram of an exemplary network system.

FIG. 2 is a schematic diagram illustrating the signaling interaction of an exemplary cloud storage method according to some embodiments of the present application.

FIG. 3 is a schematic diagram of an exemplary storage directory on a cloud storage device according to some embodiments of the present application.

FIG. 4 is a signaling interaction diagram of an exemplary cloud storage method according to some embodiments of the present application.

FIG. 5 is a signaling interaction diagram of an exemplary cloud download method according to some embodiments of the present application.

FIG. 6 is a structural schematic diagram of an exemplary push device according to some embodiments of the present application.

FIG. 7 is a structural schematic diagram of an exemplary server according to some embodiments of the present application.

FIG. 8 is a structural schematic diagram of an exemplary user terminal according to some embodiments of the present application.

FIG. 9 is a structural schematic diagram of an exemplary server according to some embodiments of the present application.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods according to some embodiments of the present disclosure, the scope of which is defined by the appended claims.

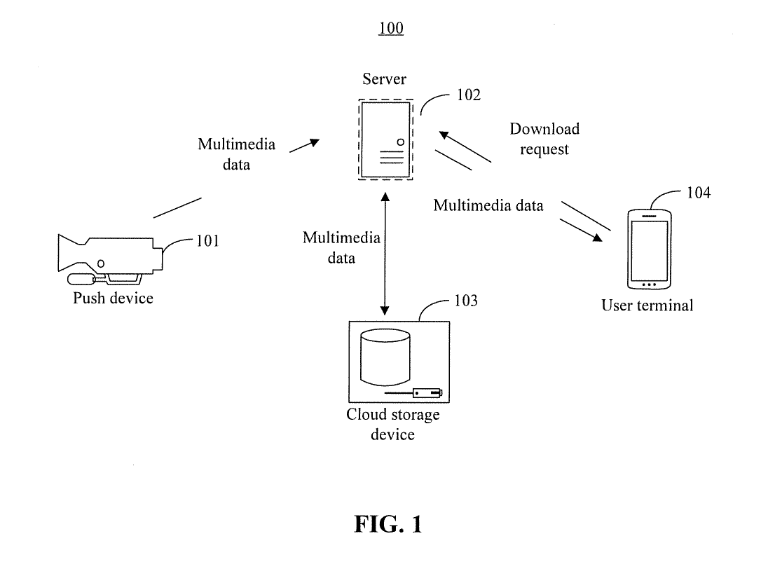

FIG. 1 shows an exemplary network system 100. The network system 100 includes a push device 101, a server 102, a cloud storage device 103, and a user terminal 104. According to some embodiments of the present application, multimedia data can include audio data, video data, video description data, or the like. The push device 101 can be a device configured to acquire and push multimedia data. The push device can be, for example, a video capturing device, or a device configured to acquire captured video data from a video capturing device. The server 102 can be a streaming media server. The cloud storage device 103 can be a device configured for cloud storage, for example, an object-based storage system. The user terminal 104 can be an electronic device such as a computer, a cell phone, or a tablet.

One existing cloud storage method for multimedia data includes: a push device 101 pushing multimedia data to a server 102; and the server 102 locally caching the multimedia data and storing the cached multimedia data in a cloud storage device 103. An existing cloud download method for multimedia data includes: a user terminal 104 sending a download request to a server 102; and the server 102 searching for and locally caching multimedia data from a cloud storage device 103, and sending the cached multimedia data to the user terminal 104.

The above cloud storage and cloud download methods have the following disadvantages. In the process of cloud storage or cloud download of multimedia data, local caching needs to be performed through the server 102, which occupies resources of the server 102. When a plurality of push devices simultaneously store multimedia data to the cloud storage device 103, or a plurality of user terminals simultaneously download multimedia data from the cloud storage device 103, the server 102 needs to locally cache large amounts of multimedia data. In such cases, a large amount of server resources may be occupied. The occupation of server resources can lead to high hardware costs for the server. Further, in the process of cloud storage or cloud download of multimedia data, the multimedia data can be easily stolen or tampered with, which results in low security. In addition, in the process of cloud storage or cloud download of multimedia data, the multimedia data needs to be segmented into a plurality of data slices if the multimedia data is of a large size, and the plurality of data slices are successively stored or downloaded. However, with the above methods, the multimedia data is inaccessible until all the data slices are stored or downloaded.

According to some embodiments of the present application, methods and apparatuses for cloud storage and cloud download of multimedia data are provided. One advantage of some embodiments of the present application is that a server does not need to perform local caching when storing multimedia to or downloading from a cloud storage device. That way, it can help reduce the occupied resources of the server and reduce hardware costs. Other advantages of some embodiments of the present application include improved security of multimedia data. Further, the data slices stored or downloaded can be accessible when the multimedia data is segmented into a plurality of data slices. That is, the multimedia data is accessible before all the data slices are stored or downloaded.

In order to facilitate understanding of the technical solutions in the present application, the technical solutions according to some embodiments of the present application are described below in conjunction with the accompanying drawings. It is appreciated that the described embodiments are only some exemplary embodiments. Other embodiment derived based on the disclosure herein shall all be encompassed in the protection scope of the present application.

According to some embodiments of the present application, in the process of cloud storage or cloud download, a server does not need to perform relays of multimedia data. Instead, a device terminal (a push device or a user terminal) can directly interact with a cloud storage device to store or download the multimedia data. In other words, the pressure for processing the multimedia data is decentralized from the server to various device ends. To ensure the security of data, the device end can send a verification request to the server before interacting with the cloud storage device. The device end can store or download the multimedia data according to permission information returned by the server, after the server successfully verifies the permission of the device end.

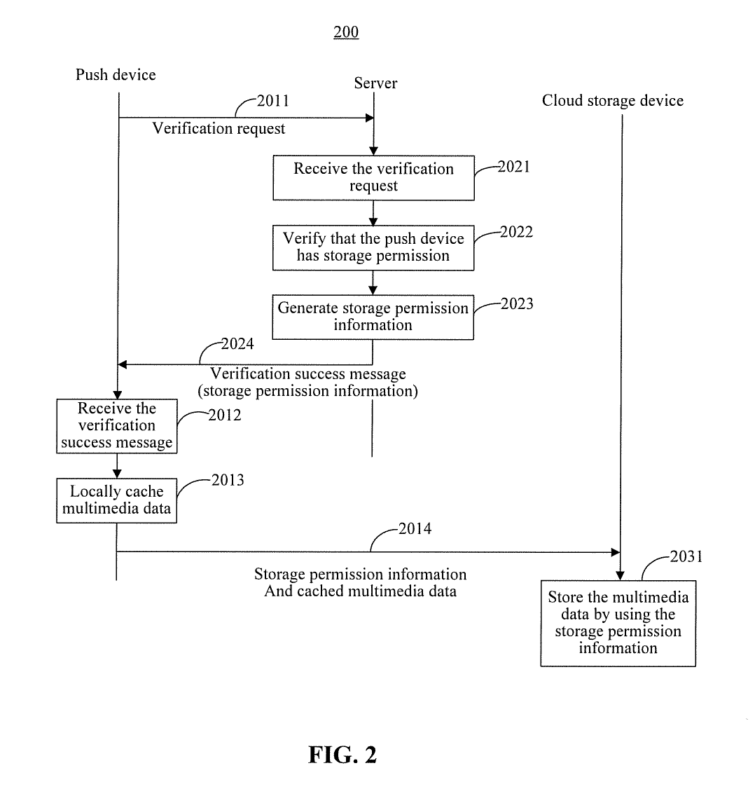

Exemplary cloud storage methods provided by some embodiments of the present application are further described below. Referring to FIG. 2, the present application provides methods for cloud storage of multimedia data. For example, the methods can apply to a push device (e.g., the push device 101 shown in FIG. 1), and the push device can be a video capturing device.

The exemplary cloud storage method 200 as shown in FIG. 2 includes steps 2011-2014, which are described below.

In step 2011, a push device sends a verification request to a server, the verification request being used for requesting verification of storage permission of the push device. The push device can send the verification request to the server when storing multimedia data to the cloud storage device. The verification request can enable the server to verify whether the push device has permission to store multimedia data on the cloud storage device. For example, the verification request can include an identifier of the push device, so that the server can identify the push device.

In some embodiments of the present application, the server can be a streaming media server (e.g., the server 102 shown in FIG. 1). In some embodiments, it can also be an authentication server.

In step 2021, the server receives a verification request sent by the push device.

In step 2022, the server verifies that the push device has the storage permission.

After receiving the verification request, the server can determine whether the push device has the storage permission according to the verification request. If the server determines that the push device has the storage permission, that is, the push device has permission to store multimedia data on the cloud storage device, steps 2023 and 2024 are performed. If the server determines that the push device does not have the storage permission, it indicates that the push device does not have permission to store multimedia data on the cloud storage device. In that case, the server can send a verification failure message to the push device. The push device can initiate the verification process again.

In step 2023, the server generates storage permission information about a specified address on a cloud storage device.

When the server verifies that the push device has the storage permission, the server can allocate a specified address and generate the storage permission information. The storage permission information can include the specified address, an identifier of the cloud storage device, and information indicating that the operation action type is a storage operation. With the storage permission information, the push device can find the cloud storage device according to the identifier and store data at the specified address of the cloud storage device according to the specified address.

In some embodiments, the storage permission information can further include an operation time for the push device, which limits the total duration during which the push device performs a storage operation on the cloud storage device. In some embodiments, the storage permission information can be an access token.

In some embodiments of the present application, the specified address can also be in the form of a specified path. For example, the specified path can be: E:\ID_01\August 1st.

In step 2024, the server sends a verification success message to the push device, the verification success message including the storage permission information. The verification success message can be used for indicating that the server has verified that the push device has storage permission for the cloud storage device.

In step 2012, the push device receives a verification success message sent by the server. The verification success message can include storage permission information about a specified address of a cloud storage device. Reference can be made to steps 2023 and 2024 for the description of the verification success message and the storage permission information.

In step 2013, the push device locally caches the multimedia data.

According to the above, in some embodiments of the present application, data relays are not performed through the server. Instead, the push device directly stores data to the cloud storage device. The data is locally cached at the push device.

Since multimedia data is generally large, in some embodiments of the present application, the size of the multimedia data locally cached by the push device every time can be smaller than the total size of the entire multimedia data. The push device can successively cache the multimedia data as a plurality of data slices, which is equivalent to slicing the multimedia data into a plurality of data slices for caching.

It is appreciated that the execution sequence of steps 2013 and 2011 is not limited to the above description. For example, it is possible to first perform step 2011 (i.e., the server performs verification) and then perform step 2013 (i.e., data is cached). Alternatively, it is also possible to first perform step 2013 and then perform step 2011.

In step 2014, the push device stores the locally cached multimedia data at the specified address of the cloud storage device by using the storage permission information. During implementation, the push device sends the storage permission information and the cached multimedia data to the cloud storage device. The cloud storage device (e.g., the cloud storage device 103 in FIG. 1) performs step 2031, to store the multimedia data at the specified address by using the storage permission information.

In some embodiments of the present application, the multimedia data is sliced into a plurality of data slices and successively cached at the push device, which may address the problem that the multimedia data is inaccessible until all the slices are stored or downloaded. The push device can store the plurality of data slices successively cached at the specified address in an appended object storage manner. The appended object storage manner refers to appending other data slices, except the first data slice, after the previous data slice, to form stream storage until a specified size of multimedia data is reached. Using the appended object storage manner, it is possible to access data slices that have been stored, that is, the multimedia data is accessible before all the data slices are stored.

In view of the above, according to some embodiments of the present application, there is no need for a server to perform data relays at the time of cloud storage of multimedia data. That is, the server does not perform local caching. Instead, the server only performs permission verification, and a push device directly stores the multimedia data. That way, the pressure of processing the multimedia data is decentralized from the server to various push devices, thereby reducing the occupied resources of the server and associated hardware costs. In addition, even though the server does not perform data relays, the server performs permission verification, which helps ensure security of the cloud storage process while reducing the occupied resources.

For multimedia data such as video data or other multimedia data that has a key frame, decoding, or playing and decoding, the multimedia data may rely on the key frame. For example, playing may start from the key frame, or the decoding of other frames is based on the key frame. In some embodiments of the present application, the push device can also acquire key frame information about the multimedia data, generate an index file according to the key frame information, and store the index file at the specified address of the cloud storage device by using the storage permission information. For example, the storage permission information, the cached multimedia data and the index file can be sent to the server together at step 2014. That way, the key frame can be quickly located, which facilitates quick playing or decoding of the multimedia data. Further, the specified address can include a first specified address and a second specified address. The multimedia data can be stored at the first specified address, and the index file can be stored at the second specified address.

In some embodiments, the key frame information can include the timestamp of the key frame, the size of the key frame, and the position of the key frame in multimedia data. That way, other devices (such as a user terminal) can easily locate the key frame according to the key frame information. For example, if the multimedia data is video data encoded based on the H.264 video encoding technique, which can also be referred to as a video code stream, the key frame information can include a timestamp of an I frame (a H.264 key frame), the size of the I frame, and the position of the I frame in the multimedia data. After acquiring the key frame information, the user terminal can locate the I frame and start playing the video data from the I frame.

In some embodiments, if the multimedia data is sliced into a plurality of data slices, the push device can successively determine whether each frame of the currently cached data slice is a key frame when successively caching the plurality of data slices, and it can acquire the key frame information upon the determination that the frame is a key frame.

In some embodiments of the present application, the verification request can further indicate the multimedia data to be stored by the push device. For example, the verification request can include the name of the multimedia data to be stored by the push device, so that the server can generate a specified address for storing the multimedia data. Exemplary processes of generating a specified address by a server are further described below.

For example, the verification request can further indicate the multimedia data to be stored by the push device. Before the server generates the storage permission information, the server can generate a specified folder on the cloud storage device. The address of the specified folder can be used as the specified address, if the server determines that the multimedia data does not exist on the cloud storage device. For example, it may be the first time for the push device to access the cloud storage device. It may also occur in cases where it is not the first time for the push device to access the cloud storage device, but the push device has not stored multimedia data in the cloud storage device. Alternatively, if the server determines that partial data of the multimedia data exists on the cloud storage device, the server can take the address where partial data of the multimedia data is located as the specified address. For example, this may occur if the push device has stored some data slices of the multimedia data on the cloud storage device.

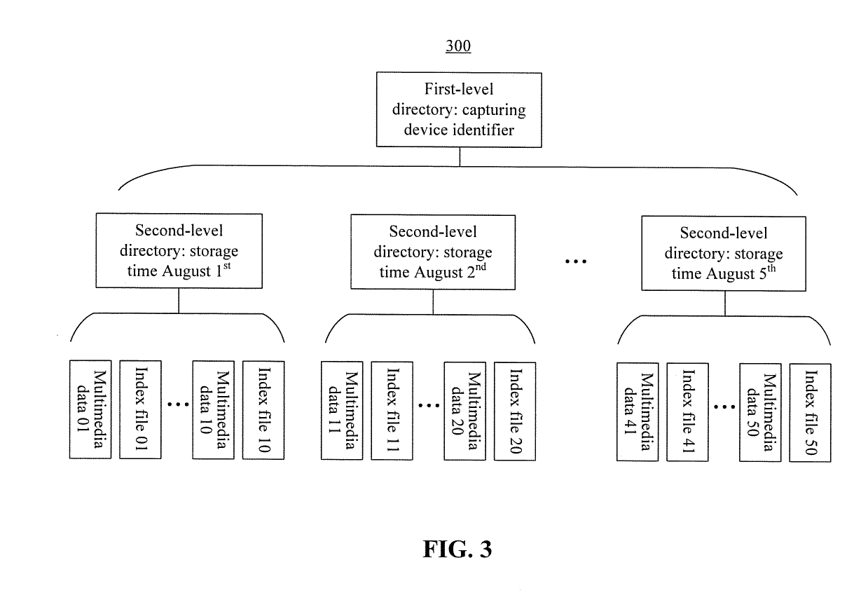

In some embodiments of the present application, the server can manage various folders on the cloud storage device, namely, file directories on the cloud storage device. For example, when establishing the folders, the server can establish them level by level according to a certain rule. For example, as shown in the example of FIG. 3, a first-level directory of the multimedia data corresponds to a capturing device identifier, and a second-level directory corresponds to storage time. The multimedia data and the index file are stored under the second-level directory, as further described below.

In this example, the first-level directory corresponds to the capturing device identifier, which indicates that the first-level directory is differentiated according to the capturing device identifier. The capturing device identifier can refer to an identifier of a device (i.e., a capturing device) that has captured the multimedia data to be stored. For example, if the capturing device is an Internet protocol camera, the capturing device identifier can be the identifier of the Internet protocol camera (IPCID). It is appreciated that, the capturing device and the push device can be the same device, and they can also be different devices.

The second-level directory corresponds to storage time, which indicates that the second-level directory is differentiated according to the time when the multimedia data is stored. For example, storage time can be on a daily basis. In other words, multimedia data stored on different days (i.e., different dates) are located in different second-level directories. For example, as shown in FIG. 3, multimedia data stored respectively on August 1st and August 2nd are separately located at different second-level directories.

The corresponding multimedia data and index file can be stored under the second-level directory. For example, as shown in FIG. 3, under the second-level directory of which the storage time is August 1st, multimedia data 01, index file 01, . . . , multimedia data 10, and index file 10 are stored.

In some embodiments, when each piece of multimedia data under the second-level directory is named, it can be named in the following manner: number of storage days+capturing device identifier+start time+total length. Here, the start time can refer to the time when the multimedia data starts to be recorded.

The above exemplary process of establishing a file enables the multimedia data to be located more easily. This may help simplify the logic for management software at a server end, thereby reducing software development cost.

According to some embodiments of the present application, in order to increase the security of multimedia data, the key frame can be further encrypted and/or signed, the process of which is further described below.

With respect to encryption, the push device can encrypt a key frame in the multimedia data before storing the locally cached multimedia data at the specified address. In other words, the key frame can be encrypted before or after the local caching, and the cached multimedia data can be sent to the cloud storage device after the encryption. Further, the push device can add information indicating that the key frame has been encrypted to the key frame information before storing the index file at the specified address. That way, other devices (e.g., a user terminal) can determine, according to the key frame information, that the key frame has been encrypted. For example, the key frame can be encrypted by means of an encryption algorithm (e.g., a DES encryption algorithm), and a key can be input through the user terminal at the time of decryption.

With respect to the mode of signing, in some embodiments, the push device can generate signature information. The signature information can uniquely identify a key frame of the multimedia data, thus preventing tampering of the key frame. The push device can add the signature information to a user-defined information segment of the multimedia data, before storing the locally cached multimedia data at the specified address. For example, when the multimedia data is video data, an MD5 (Message Digest 5) code can be generated according to the I frame of the video data. The MD5 code can be added to user information in SEI (H.264 Supplemental Enhancement Information) of the video data.

It is appreciated that with the above-described embodiments of the present application, the security of a key frame can be improved by way of encrypting and/or signing the key frame, thereby ensuring security for the multimedia data.

In some embodiments of the present application, label information can also be added, which can facilitate convenient query and anti-tampering functions. For example, in some embodiments, the push device can generate label information, which can be used for describing a data characteristic of the multimedia data. The push device can add the label information to the index file before storing the index file at the specified address. For example, the label information can be added after the key frame information. For example, if the multimedia data is video data, the label information can include at least one of the following information: human-related information (e.g., features such as the number and clothing color of humans in the video data), vehicle-related information (e.g., features such as the number, license plate number, color, and type of vehicles in the video data), and other information, such as information related to animals and non-motor vehicles.

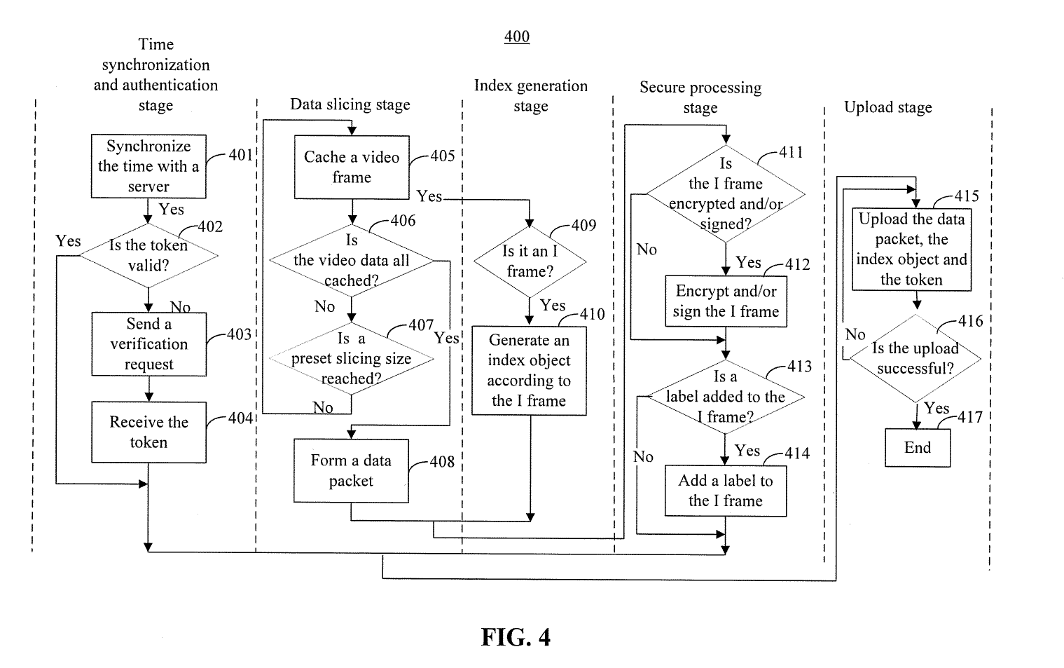

FIG. 4 is a signaling interaction diagram of an exemplary cloud storage method 400 according to some embodiments of the present application. In this example, the push device is a video capturing device, the multimedia data is video data, and the cloud storage device is an object-based storage system. It is appreciated that the foregoing limitations may not limit other embodiments of the present application.

In this example, the cloud storage method 400 includes five stages: a time synchronization and authentication stage, a data slicing stage, an index generation stage, a secure processing stage, and an upload stage. The five stages are respectively described below.

As shown in FIG. 4, the time synchronization and authentication stage includes steps 401 to 404.

In step 401, the video capturing device initiates a time synchronization request to the server. The server returns a current time to the video capturing device after verifying that the time synchronization request is valid. The video capturing device receives the time and synchronizes with the server time.

In some embodiments, the video capturing device can also determine whether the time synchronization is successful. If the time synchronization is successful, step 402 is performed. If the time synchronization is not successful, the synchronization may be performed again.

In step 402, the video capturing device determines whether there is a valid token. If there is a valid token, it indicates that the time synchronization and authentication stage has been completed. If there is no valid token, step 403 can be performed.

In some embodiments, the token can indicate a specified address that the video capturing device can operate (which can also be understood as a video object that can be operated), an identifier of the object-based storage system, information indicating that the operation action type is a storage operation, an operation time, or the like.

In step 403, the video capturing device sends a verification request to the server. The verification request can be used for requesting verification of the storage permission of the push device.

In step 404, the video capturing device receives a verification success message sent by the server. The verification success message includes the token generated by the server. Receiving the token is equivalent to acquiring the permission to store data to the specified address of the object-based storage system.

The data slicing stage includes steps 405 to 408.

In step 405, the video capturing device caches one video frame in the video data.

In step 406, the video capturing device determines whether the video data has all been cached. If all the video data has been cached, step 408 is performed. In step 408, the video capturing device forms a data packet according to the currently cached video frame.

If in step 406 it is determined that the video data has not all been cached, step 407 is performed. In step 407, the video capturing device determines whether the currently cached video frame has reached a preset slice size. If the preset slice size has been reached, step 408 is performed. If the preset slice size has not been reached, the process returns to step 405. Further, in some embodiments, when it is determined that the preset slice size has been reached, the process can also return to step 405 to continue to cache the next piece of sliced data.

By performing steps 405 to 408, the video data can be sliced into a plurality of data packets. For example, a preset slice size can be 64k bytes. The video data can be sliced into a plurality of data packets of 64k bytes, wherein the size of the last data packet may be smaller than 64k bytes.

The index generation stage includes steps 409 and 410.

In step 409, after step 405 is performed in the data slicing stage, i.e., after caching one video frame, the video capturing device determines whether the video frame is a key frame. For example, the video capturing device can determine whether the video frame is an I frame. If the video frame is determined to be an I frame, step 410 is performed. If the video frame is not an I frame, the video frame may not be processed, for example, in cases where the video frame is a B frame or a P frame.

In step 410, the video capturing device generates an index object according to the I frame. In this example, since the cloud storage device is an object-based storage system, the video data and the index file can both be stored as objects, i.e., as a video object and an index object respectively.

The secure processing stage includes steps 411 to 414.

In step 411, the video capturing device determines whether the I frame needs to be encrypted and/or signed. If the I frame needs to be encrypted and/or signed, step 412 is performed. If the I frame does not need to be encrypted and/or signed, step 413 is performed.

In step 412, the video capturing device encrypts and/or signs the I frame.

In step 413, the video capturing device determines whether label information needs to be added. If it is determined that label information needs to be added, step 414 is performed. If it is determined that label information does not need to be added, the secure processing stage is completed.

In step 414, the video capturing device adds the label information to the index object, the label information being used for describing a data characteristic of the video data.

The upload stage includes steps 415 to 417.

In step 415, after the other four stages are performed, the video capturing device uploads the data packets, the index object (if any), and the token. That is, the video capturing device sends the data to the object-based storage system.

In some embodiments, the data packets can be uploaded in an appended object storage manner, and other data packets except the first data packet can be appended after the previous data packet, to form streaming video storage until a specified size of the video data is reached. The video data in its entirety (i.e., equivalent to a video object) can correspond to one index object.

In step 416, the video capturing device determines whether the upload is successful. If the upload is successful, step 417 is performed, and the process is completed. Other video data can be stored subsequently. If the video capturing device determines that the upload is not successful, step 415 can be performed again to re-upload the data.

In some embodiments, if the upload fails, the video capturing device can also detect whether it is due to authentication timeout or network timeout. If it is detected that the failure is caused by authentication timeout, authentication can be performed again by performing steps 402 to 404. If it is detected that the failure is caused by network timeout, the data can be re-uploaded.

Exemplary cloud storage methods provided in the present application are described above from the perspective of a push device. Permission verification methods according to some embodiments of the present application are described below from the perspective of the server.

Referring back to FIG. 2, the present application provides methods for permission verification. One exemplary permission verification method applying to a cloud storage process can include steps 2021-2024.

In step 2021, the server receives a verification request sent by a push device. The verification request can be used for requesting verification of storage permission of the push device.

In step 2022, the server verifies that the push device has the storage permission.

In step 2023, the server generates storage permission information about a specified address on a cloud storage device.

In step 2024, the server sends a verification success message to the push device. The verification success message can include the storage permission information.

Steps 2021 to 2024 and related processes have been described above with respects to the cloud storage method embodiments, which are not repeated here.

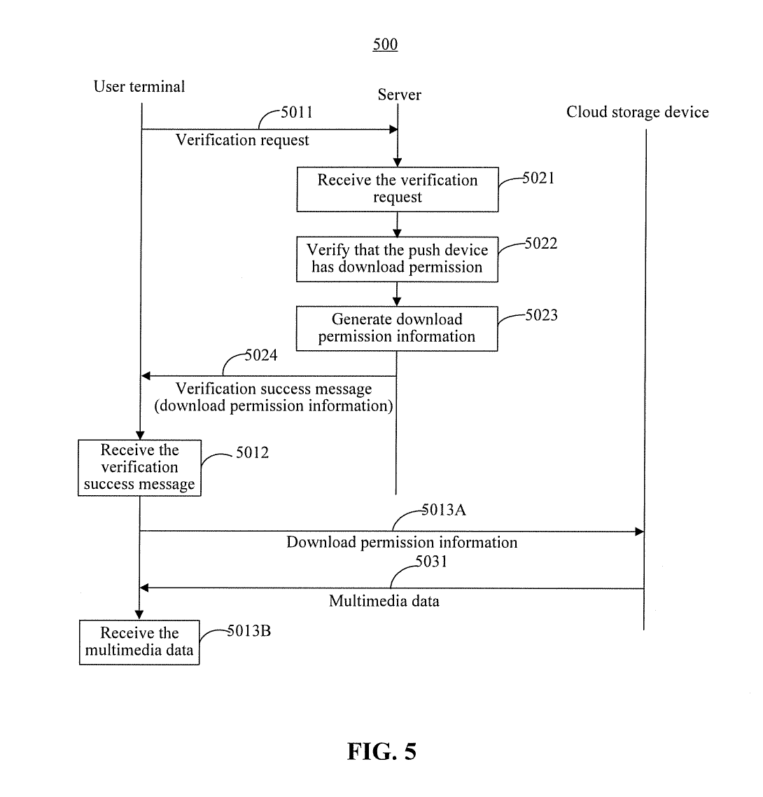

According to some embodiments of the present application, cloud download methods are provided. FIG. 5 is a signaling interaction diagram of an exemplary cloud download method 500 according to some embodiments of the present application. For example, the exemplary method 500 can apply to a user terminal (e.g., the user terminal 104 shown in FIG. 1). The exemplary cloud download method 500 includes steps 5011-5013.

In step 5011, a user terminal sends a verification request to a server. The verification request can be used for requesting verification of the download permission of the user terminal.

For example, the user terminal can send the verification request to the server when the user terminal needs to download multimedia data from the cloud storage device. The verification request can enable the server to verify whether the user terminal has permission to download the multimedia data from the cloud storage device. The verification request can include an identifier of the user terminal, so that the server can identify the user terminal.

In step 5021, the server receives a verification request sent by the user terminal.

In step 5022, the server verifies that the user terminal has the download permission.

After receiving the verification request, the server may determine whether the user terminal has the download permission according to the verification request. If it is determined that the user terminal has the download permission, it indicates that the user terminal has permission to download multimedia data from the cloud storage device. Step 5023 can then be performed. If it is determined that the user terminal does not have the download permission, it indicates that the user terminal does not have permission to download multimedia data from the cloud storage device. In that case, the server can send a verification failure message to the user terminal. The user terminal can initiate the verification process again.

In some embodiments, the user terminal only has the download permission for the data stored by a corresponding push device corresponding to the user terminal. In that case, the server verifies that the user terminal has the download permission for the data stored by the corresponding push device.

In step 5023, the server generates download permission information about a specified address on a cloud storage device.

When the server verifies that the user terminal has the download permission, the server may acquire a specified address (for example, the address of data stored by the push device corresponding to the user terminal), and generate the download permission information. The download permission information can include the specified address, the identifier of the cloud storage device, and information indicating that the operation action type is a download operation. The user terminal can locate the cloud storage device according to the identifier, and download data from the specified address of the cloud storage device accordingly.

In some embodiments, the download permission information can further include an operation time for the user terminal, which limits the total duration during which the user terminal can perform a download operation on the cloud storage device. In some embodiments, the download permission information can be an access token.

In step 5024, the server sends a verification success message to the user terminal. The verification success message can include the download permission information. The verification success message can be used for indicating that the server verifies that the user terminal has the download permission on the cloud storage device. Reference can be made to step 5023 for the description of the download permission information, which is not described further here.

In step 5012, the user terminal receives a verification success message sent by the server. The verification success message can include download permission information about a specified address of a cloud storage device. Reference can be made to steps 5023 and 5024 for the descriptions of the verification success message and the download permission information, which are not described further here.

In step 5013, the user terminal uses the download permission information to download multimedia data from the specified address. In some embodiments, this can further include the following substeps. The user terminal downloads an index file from the specified address by using the download permission information, the index file including key frame information about the multimedia data. The key frame information can include the timestamp of the key frame, the size of the key frame, and the position of the key frame in the multimedia data. That way, the user terminal can locate the key frame according to the key frame information.

As shown in FIG. 5, step 5013 includes steps 5013A and 5013B.

In 5013A, the user terminal sends the download permission information to the cloud storage device. The cloud storage device can find, according to the download permission information, multimedia data correspondingly stored at the specified address, and perform step 5031, that is, send the multimedia data to the user terminal.

In step 5013B, the user terminal receives the multimedia data sent by the cloud storage device.

In some embodiments of the present application, the multimedia data may be sliced into a plurality of data slices and successively downloaded from the cloud storage device. This may help address the problem that the multimedia data is inaccessible until all the data slices are downloaded. In that case, the user terminal can download the plurality of data slices successively to the user terminal in an appended object storage manner. The appended object storage manner makes it possible to access downloaded data slices. That is, the multimedia data is accessible before all the data slices are downloaded.

In view of the above exemplary embodiments, there is no need for a server to perform data relays at the time of cloud download of multimedia data. That is, the server does not need to perform local caching. Instead, the server only needs to perform permission verification, and a user terminal can directly download the multimedia data. That way, the pressure of processing the multimedia data is decentralized from the server to various user terminals, thus reducing the occupied resources of the server, and reducing associated hardware costs. In addition, according to some embodiments of the present application, even though the server does not perform data relays, the server performs permission verification, thereby ensuring the security of a cloud download process while reducing the occupied resources.

In some embodiments, the cloud storage method can further include: the user terminal parsing the index file to obtain the key frame information; and the user terminal playing the multimedia data according to the key frame information. For example, the user terminal can acquire the position of the key frame in the multimedia data through the key frame information in the index file, and play the multimedia data according to the acquired position.

In some embodiments, the cloud storage method can further include: the user terminal decrypting the key frame before playing the multimedia data according to the key frame information. For example, this may occur in cases where the user terminal acquires, from the key frame information, information indicating that the key frame has been encrypted. In some embodiments, the user terminal can prompt the user to input a key for decryption.

In some embodiments of the present application, the user terminal can play live or on-demand multimedia data, which are further described below.

For example, if the user terminal is in a live state, the server can acquire the most recently stored multimedia data, and take the address of the most recently stored multimedia data as the specified address.

Assuming that the multimedia data is stored in the manner as shown in FIG. 3, the server can locate the corresponding entire video data and index file, according to the identifier of the video capturing device to be accessed and the current time. The server can then find key frame information with the most recent time, based on time information recorded in the key frame information and a comparison to the current time. Accordingly, the server can find the video data and index file corresponding to the key frame information with the most recent time. The server can then take the address where the corresponding video data and index file are located as the specified address, to generate download permission information.

If the user terminal is in an on-demand state, the server can acquire the identifier of the on-demand data of the user terminal, and take the storage address corresponding to the identifier of the on-demand data as the specified address. For example, the identifier of the on-demand data can include the capturing device identifier and the storage time.

For example, the user terminal can find the corresponding entire video data and index file, according to the identifier of the video capturing device to be accessed and the time of the on-demand video. The user terminal can then find the key frame information corresponding to the time of the on-demand video through the time information recorded in the key frame information. Based on the key frame information, the user terminal can find the video data and index file corresponding to the key frame information and take the address where the corresponding video data and index file are located as the specified address, so as to generate download permission information.

The exemplary cloud download method according to some embodiments of the present application is introduced above from the perspective of the user terminal. According to some embodiments of the present application, permission verification methods are provided, which are described below from the perspective of the server.

According to some embodiments of the present application, methods for permission verification are provided. Referring back to FIG. 5, an exemplary permission verification method includes the steps 5021 to 5024. The exemplary method can be applied to a cloud download process.

In step 5021, the server receives a verification request sent by a user terminal. The verification request can be used for requesting verification of download permission of the user terminal.

In step 5022, the server verifies that the user terminal has the download permission.

In step 5023, the server generates download permission information about a specified address on a cloud storage device.

In step 5024, the server sends a verification success message to the user terminal. The verification success message can include the download permission information.

Reference can be made to the detailed description of steps 5021-5024 above with respect to the cloud download method embodiments.

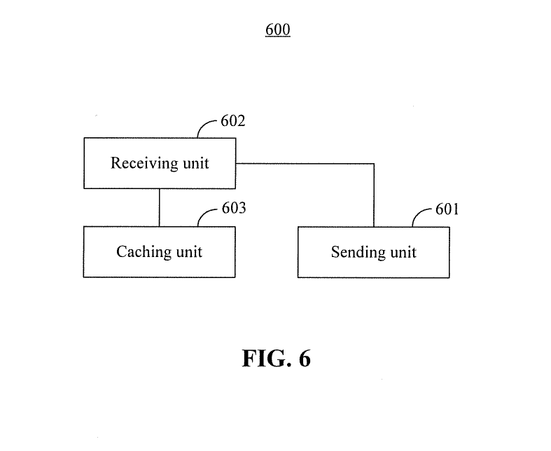

According to some embodiments of the present application, push devices are provided, which can be used as, for example, the push device 101 shown in FIG. 1. FIG. 6 is a structural schematic diagram of an exemplary push device 600 according to some embodiments of the present application. The exemplary push device 600 includes: a sending unit 601, a receiving unit 602 and a caching unit 603.

The sending unit 601 can be configured to send a verification request to a server. The verification request can be used for requesting verification of the storage permission of the push device. For example, the push device can send the verification request to the server when needing to store multimedia data to the cloud storage device. The verification request can enable the server to verify whether the push device has permission to store multimedia data on the cloud storage device. The verification request can include an identifier of the push device, so that the server can identify the push device.

In some embodiments of the present application, the server can be a streaming media server (e.g., the server 102 shown in FIG. 1), or an authentication server.

The receiving unit 602 can be configured to receive a verification success message sent by the server. The verification success message can include storage permission information about a specified address of a cloud storage device.

After receiving the verification request, the server may determine whether the push device has the storage permission according to the verification request. If it is determined that the push device has the storage permission, it indicates that the push device has permission to store multimedia data on the cloud storage device. A verification success message can be sent to the push device. If it is determined that the push device does not have storage permission, it indicates that the push device does not have permission to store multimedia data on the cloud storage device. In that case, the server can send a verification failure message to the push device. The push device can initiate the verification process again.

The caching unit 603 can be configured to locally cache the multimedia data.

In some embodiments, the size of the multimedia data can be large. The size of the multimedia data locally cached by the caching unit 603 every time can be smaller than the total size of the multimedia data. The cashing unit 603 can successively cache the multimedia data as a plurality of data slices, namely, the multimedia data can be sliced into a plurality of data slices for caching.

The sending unit 601 can be further configured to store the locally cached multimedia data at the specified address of the cloud storage device by using the storage permission information.

In some embodiments, the sending unit 601 can be configured to send the storage permission information and the cached multimedia data to the cloud storage device, so that the cloud storage device (e.g., the cloud storage device 103 in FIG. 1) can store the multimedia data at the specified address by using the storage permission information.

In some embodiments of the present application, the multimedia data is sliced into a plurality of data slices and successively cached at the push device. This may help address the problem that the multimedia data is inaccessible until all the data slices all stored. In that case, the sending unit 601 can store the plurality of data slices successively cached at the specified address in an appended object storage manner

In some embodiments, the push device can further include a first generation unit configured to acquire key frame information about the multimedia data and generate an index file according to the key frame information. The sending unit 601 can be further configured to store the index file at the specified address of the cloud storage device by using the storage permission information.

In some embodiments, the push device can further include an encryption unit, and a first addition unit. The encryption unit can be configured to encrypt a key frame in the multimedia data before the sending unit 601 stores the locally cached multimedia data at the specified address. The first addition unit can be configured to add information indicating that the key frame has been encrypted to the key frame information, before the sending unit 601 stores the index file at the specified address.

In some embodiments, the push device can further include a second generation unit, and a second addition unit. The second generation unit can be configured to generate label information. The label information can be used for describing a data characteristic of the multimedia data. The second addition unit can be configured to add the label information to the index file, before the sending unit 601 stores the index file at the specified address.

In some embodiments, the push device can further include a third generation unit, and a third addition unit. The third generation unit can be configured to generate signature information, the signature information being capable of uniquely identifying a key frame of the multimedia data. The third addition unit can be configured to add the signature information to a user-defined information segment of the multimedia data, before the sending unit 601 stores the locally cached multimedia data at the specified address.

In some embodiments, the caching unit 603 can be further configured to successively cache the multimedia data as a plurality of data slices. The sending unit 601 can be configured to store the successively cached plurality of data slices at the specified address in an appended object storage manner, when storing the locally cached multimedia data at the specified address.

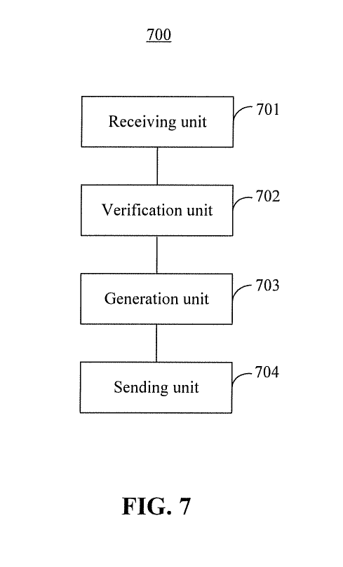

According to some embodiments of the present application, servers are provided. FIG. 7 is a structural schematic diagram of an exemplary server 700 according to some embodiments of the present application. The exemplary server 700 can be used in a cloud storage process. As shown in FIG. 7, the exemplary server 700 includes: a receiving unit 701, a verification unit 702, a generation unit 703, and a sending unit 704.

The receiving unit 701 can be configured to receive a verification request sent by a push device. The verification request can be used for requesting verification of the storage permission of the push device.

The verification unit 702 can be configured to verify that the push device has the storage permission.

The generation unit 703 can be configured to generate storage permission information about a specified address on a cloud storage device, after the verification unit 702 verifies that the push device has the storage permission.

The sending unit 704 can be configured to send a verification success message to the push device. The verification success message can include the storage permission information.

In some embodiments, the verification request can further indicate the multimedia data to be stored by the push device. The server 700 can further include a determination unit. The determination unit can be configured to determine whether the multimedia data exists on the cloud storage device. If it is determined that the multimedia data does not exist on the cloud storage device, the determination unit can be further configured to: before the generation unit 703 generates the storage permission information, generate a specified folder on the cloud storage device, and take an address corresponding to the specified folder as the specified address. If it is determined that that partial data of the multimedia data exists on the cloud storage device, the determination unit can be configured to take the address where partial data of the multimedia data is located as the specified address. In some embodiments, a first-level directory of the multimedia data can correspond to a capturing device identifier, and a second-level directory can correspond to storage time.

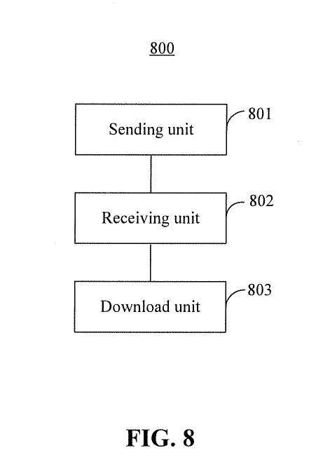

According to some embodiments of the present application, user terminals are provided. FIG. 8 is a structural schematic diagram of an exemplary user terminal 800 according to some embodiments of the present application. The exemplary user terminal 800 can be used as, for example, the user terminal 104 shown in FIG. 1. As shown in FIG. 8, the exemplary user terminal 800 includes a sending unit 801, a receiving unit 802, and a download unit 803.

The sending unit 801 can be configured to send a verification request to a server. The verification request can be used for requesting verification of the download permission of the push device. The verification request can include an identifier of the user terminal, so that the server can identify the user terminal.

The receiving unit 802 can be configured to receive a verification success message sent by the server. The verification success message can include download permission information about a specified address of a cloud storage device.

After receiving the verification request, the server may determine whether the user terminal has the download permission, according to the verification request. If it is determined that the user terminal has the download permission, it indicates that the user terminal has permission to download multimedia data from the cloud storage device. A verification success message can be sent to the user terminal. If it is determined that the user terminal does not have the download permission, it indicates that the user terminal does not have permission to download multimedia data from the cloud storage device. In that case, the server can send a verification failure message to the user terminal. The user terminal can initiate the verification process again.

In some embodiments, the user terminal only has the download permission for the data stored by the push device corresponding to the user terminal. The server can verify that the user terminal has the download permission for the data stored by the push device corresponding to the user terminal.

The download unit 803 can be configured to download multimedia data from the specified address by using the download permission information. In some embodiments, the download unit 803 can be configured to send the download permission information to a cloud storage device, and receive the multimedia data sent by the cloud storage device.

In some embodiments of the present application, the multimedia data is sliced into a plurality of data slices and successively downloaded from the cloud storage device. The download unit 803 can successively download the plurality of data slices to the user terminal in an appended object storage manner.

In some embodiments, the download unit 803 can be further configured to download an index file from the specified address by using the download permission information. The index file can include key frame information about the multimedia data.

In some embodiments, the user terminal 800 can further includes a parsing unit and a playing unit. The parsing unit can be configured to parse the index file to obtain the key frame information. The playing unit can be configured to play the multimedia data according to the key frame information.

In some embodiments, the user terminal 800 can further include a decryption unit. If information indicating that the key frame has been encrypted is acquired from the key frame information, the decryption unit can be configured to decrypt the key frame, before the multimedia data is played according to the key frame information. For example, the user terminal can prompt the user to input a key for decryption.

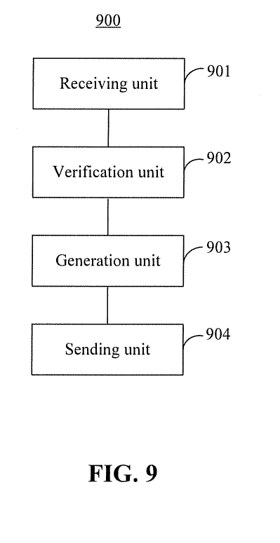

FIG. 9 is a structural schematic diagram of an exemplary server 900 according to some embodiments of the present application. The exemplary server 900 can be used in a cloud download process. As shown in FIG. 9, the exemplary server 900 includes: a receiving unit 901, a verification unit 902, a generation unit 903, and a sending unit 904.

The receiving unit 901 can be configured to receive a verification request sent by a user terminal. The verification request can be used for requesting verification of the download permission of the user terminal.

The verification unit 902 can be configured to verify that the user terminal has the download permission.

The generation unit 903 can be configured to generate download permission information about a specified address on a cloud storage device, after the verification unit 902 verifies that the user terminal has the download permission.

The sending unit 904 can be configured to send a verification success message to the user terminal. The verification success message can include the download permission information.

In some embodiments, the server 900 can further include an acquisition unit. The acquisition unit can be configured to: if the user terminal is in a live state, acquire the most recently stored multimedia data, and take the address of the most recently stored multimedia data as the specified address. If the user terminal is in an on-demand state, the acquisition unit can be configured to: acquire an identifier of on-demand data of the user terminal, and take the storage address corresponding to the identifier of the on-demand data as the specified address.

It is appreciated that reference can be made to the description of corresponding processes in the foregoing method embodiments for detailed description of the system, apparatuses and units described above. The details are repeated here for the conciseness of the description.

It should be appreciated that the disclosed systems, apparatuses and methods can be implemented in other ways, consistent with the several embodiments provided in the present disclosure. The method and apparatus embodiments described above are merely illustrative. For example, the division of the units represents only the division of logical functions. Division in another manner may exist in actual implementation. For example, a plurality of units or components may be combined or integrated into another system, or some features may be omitted in some embodiments. In addition, the mutual coupling or direct coupling or communication connections displayed or discussed may be implemented by using certain interfaces. The indirect coupling or communication connections between the apparatuses or units may be implemented electrically, mechanically, or in another form.

The units described above as separate parts may or may not be physically separated. Parts displayed as units may or may not be physical units, i.e., the components can either be at the same place or be distributed over a plurality of network units. Some or all of the units may be selectively used according to actual needs to achieve the objectives of the embodiments.

Furthermore, various functional units in various embodiments of the present application can be integrated in one processing unit. The various units can also physically exist individually, or two or more units can also be integrated in one unit. The integrated units described above can be implemented in the form of hardware, or in the form of software functional units.

The integrated units described above, if implemented in the form of software functional units and sold or used as independent products, can be stored in a computer readable storage medium. Based on such understanding, the essence of the technical solutions disclosed herein, or all or a part of the technical solutions may be implemented in the form of a software product. The computer software product can be stored in a storage medium, and it can include several instructions to enable a computer device (which can be a personal computer, a server, a network device, a mobile device, or the like), or a processor to carry out all or some of the steps according to various embodiments of the present application.

The foregoing storage medium may include, for example, any medium that can store a program code, such as a USB flash disk, a removable hard disk, a Read-Only Memory (ROM), a Random Access Memory (RAM), a magnetic disk, or an optical disc. The storage medium can be a non-transitory computer readable medium. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM any other memory chip or cartridge, and networked versions of the same.

The foregoing described embodiments are merely used for illustrating the technical solutions of the present application. Although some embodiments of the present application have been described above, persons of ordinary skill in the art should appreciate that modifications can be made to the technical solutions in view of the foregoing embodiments, or that equivalent replacements can be made to some technical features in the technical solutions. Such modifications or replacements do not cause the nature of the corresponding technical solutions to depart from the spirit and scope of the technical solutions of the embodiments of the present application, and shall all fall within the protection scope of the present application.

1. A cloud storage method for multimedia data, the method being performed by a push device and comprising:
sending a verification request to a server, the verification request being used for requesting verification of storage permission of the push device;
receiving a verification success message sent by the server, the verification success message including storage permission information about a specified address of a cloud storage device;
caching the multimedia data; and
storing the cached multimedia data at the specified address of the cloud storage device, based on the storage permission information.

2. The cloud storage method according to claim 1, further comprising:
storing the cached multimedia data at the specified address of the cloud storage device without transmitting the cached multimedia data to the server.

3. The cloud storage method according to claim 1, further comprising:
acquiring key frame information about the multimedia data;
generating an index file according to the key frame information; and
storing the index file at the specified address of the cloud storage device, based on the storage permission information.

4. The cloud storage method according to claim 3, further comprising:
encrypting a key frame in the multimedia data before storing the cached multimedia data at the specified address; and
adding information indicating that the key frame has been encrypted to the key frame information before storing the index file at the specified address.

5. The cloud storage method according to claim 3, further comprising:
generating label information for describing a data characteristic of the multimedia data; and
adding the label information to the index file before storing the index file at the specified address.

6. The cloud storage method according to claim 1, further comprising:
generating signature information, the signature information being capable of identifying a key frame of the multimedia data; and
adding the signature information to a user-defined information segment of the multimedia data before storing the cached multimedia data at the specified address.

7. The cloud storage method according to claim 1, wherein caching the multimedia data comprises caching the multimedia data as a plurality of data slices; and
wherein storing the cached multimedia data at the specified address comprises storing the cached plurality of data slices at the specified address in an appended object storage manner.

8. A permission verification method used in a cloud storage process, the method being performed by a server and comprising:
receiving a verification request sent by a push device, the verification request being used for requesting verification of storage permission of the push device;
verifying that the push device has the storage permission;
generating storage permission information about a specified address on a cloud storage device; and
sending a verification success message to the push device, the verification success message including the storage permission information.

9. The permission verification method according to claim 8, wherein the verification request further indicates multimedia data to be stored by the push device; and
wherein, before generating the storage permission information, the method further comprises:
generating a specified folder on the cloud storage device, and taking an address corresponding to the specified folder as the specified address; or
taking the address where partial data of the multimedia data is located on the cloud storage device as the specified address.

10. The permission verification method according to claim 9, wherein a first-level directory of the multimedia data corresponds to a capturing device identifier, and a second-level directory corresponds to storage time.

11-31. (canceled)

32. A non-transitory computer readable medium that stores a set of instructions that is executable by at least one processor of a push device to cause the push device to perform a cloud storage method for multimedia data, the method comprising:
sending a verification request to a server, the verification request being used for requesting verification of storage permission of the push device;
receiving a verification success message sent by the server, the verification success message including storage permission information about a specified address of a cloud storage device;
caching the multimedia data; and
storing the cached multimedia data at the specified address of the cloud storage device, based on the storage permission information.

33. The non-transitory computer readable medium according to claim 32, wherein the set of instructions that is executable by the at least one processor of the push device causes the push device to further perform:
acquiring key frame information about the multimedia data;
generating an index file according to the key frame information; and
storing the index file at the specified address of the cloud storage device, based on the storage permission information.

34. The non-transitory computer readable medium according to claim 32, wherein the set of instructions that is executable by the at least one processor of the push device causes the push device to further perform:
encrypting a key frame in the multimedia data before storing the cached multimedia data at the specified address; and
adding information indicating that the key frame has been encrypted to the key frame information before storing the index file at the specified address.

35. The non-transitory computer readable medium according to claim 33, wherein the set of instructions that is executable by the at least one processor of the push device causes the push device to further perform:
generating label information for describing a data characteristic of the multimedia data; and
adding the label information to the index file before storing the index file at the specified address.

36. The non-transitory computer readable medium according to claim 32, wherein the set of instructions that is executable by the at least one processor of the push device causes the push device to further perform:
generating signature information, the signature information being capable of identifying a key frame of the multimedia data; and
adding the signature information to a user-defined information segment of the multimedia data before storing the cached multimedia data at the specified address.

37. The non-transitory computer readable medium according to claim 32,
wherein caching the multimedia data comprises:
caching the multimedia data as a plurality of data slices; and
wherein storing the cached multimedia data at the specified address comprises:
storing the cached plurality of data slices at the specified address in an appended object storage manner.

38. A non-transitory computer readable medium that stores a set of instructions that is executable by at least one processor of a server to cause the server to perform a permission verification method used in a cloud storage process, the method comprising:
receiving a verification request sent by a push device, the verification request being used for requesting verification of storage permission of the push device;
verifying that the push device has the storage permission;
generating storage permission information about a specified address on a cloud storage device; and
sending a verification success message to the push device, the verification success message including the storage permission information.

39. The non-transitory computer readable medium according to claim 38,
wherein the verification request further indicates multimedia data to be stored by the push device; and
wherein, before generating the storage permission information, the set of instructions that is executable by the at least one processor of the server causes the server to further perform:
generating a specified folder on the cloud storage device, and taking an address corresponding to the specified folder as the specified address; or
taking the address where partial data of the multimedia data is located on the storage device as the specified address.

40. The non-transitory computer readable medium according to claim 39, wherein a first-level directory of the multimedia data corresponds to a capturing device identifier, and a second-level directory corresponds to storage time.

41-46. (canceled)
